(19) United States
(12) Patent Application Publication
(10) Pub. No.: US 2022/0375648 A1
(43) Pub. Date: Nov. 24, 2022

(54) Ribbon Cable

(71) Applicants: Tyco Electronics (Shanghai) Co. Ltd, Shanghai (CN); TE Connectivity Services GmbH, Schaffhausen (CH)

(72) Inventors: Zhiwei (Jack) Guo, Dongguan (CN); Hainan (Harlan) Lu, Dongguan (CN); Jonathan Edward Lee, Middletown, PA (US)

(73) Assignees: Tyco Electronics (Shanghai) Co. Ltd, Shanghai (CN); TE Connectivity Services GmbH, Schaffhausen (CH)

(21) Appl. No.: 17/747,307

(22) Filed: May 18, 2022

(30) Foreign Application Priority Data
May 21, 2021 (CN) 202110562052.8

(51) Int. Cl. H01B 7/08; H01B 13/00

(52) U.S. Cl. CPC H01B 7/0838; H01B 13/0036

(57) ABSTRACT

A ribbon cable includes a plurality of cable groups arranged side by side with a gap between each pair of adjacent cable groups, a first covering film arranged on a first side of the cable groups, and a second covering film arranged on a second side of the cable groups opposite the first covering film. The first covering film has a first bonding portion and a first spacing portion. The second covering film has a second bonding portion and a second spacing portion. The first bonding portion and the second bonding portion are bonded to each of the cable groups. The first spacing portion and the second spacing portion are located at the gap and are separated from each other.

### CROSS-REFERENCE TO RELATED APPLICATION

This application claims the benefit of the filing date under 35 U.S.C. § 119(a)-(d) of Chinese Patent Application No. 202110562052.8, filed on May 21, 2021.

### FIELD OF THE INVENTION

Embodiments of the present disclosure generally relate to a cable, and more particularly, to a ribbon cable, such as a twinaxial cable, that is capable of data transmission at high data transmission rates.

### BACKGROUND

In the related art, a high-speed data transmission ribbon cable such as a twinaxial cable mainly includes a plurality of cable groups arranged side by side, a covering film is provided on one side of the plurality of cable groups, and the plurality of cable groups are bonded to the covering film by hot melt adhesive on the covering film to form the ribbon cable. However, such a cable fixing structure of the existing ribbon cable is extremely unstable, and the cables easily fall off and become loose, which makes the assembly unusable. In addition, because the covering film is only attached to one side of these cable groups, the hot melt adhesive on the covering film is exposed to the air, is easily affected by the external environment, and is prone to failure, which is even more unfavorable for the fixing of the cable.

### SUMMARY

A ribbon cable includes a plurality of cable groups arranged side by side with a gap between each pair of adjacent cable groups, a first covering film arranged on a first side of the cable groups, and a second covering film arranged on a second side of the cable groups opposite the first covering film. The first covering film has a first bonding portion and a first spacing portion. The second covering film has a second bonding portion and a second spacing portion. The first bonding portion and the second bonding portion are bonded to each of the cable groups. The first spacing portion and the second spacing portion are located at the gap and are separated from each other.

### BRIEF DESCRIPTION OF THE DRAWINGS

The invention will now be described by way of example with reference to the accompanying Figures, of which:

FIG. 1 is a perspective view of a ribbon cable according to an embodiment;

FIG. 2 is a sectional view of the ribbon cable of FIG. 1; and

FIG. 3 is an exploded view of the ribbon cable of FIG. 1.

### DETAILED DESCRIPTION OF THE EMBODIMENTS

Embodiments of the present disclosure will be described hereinafter in detail taken in conjunction with the accompanying drawings. In the description, the same or similar parts are indicated by the same or similar reference numerals. The description of embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

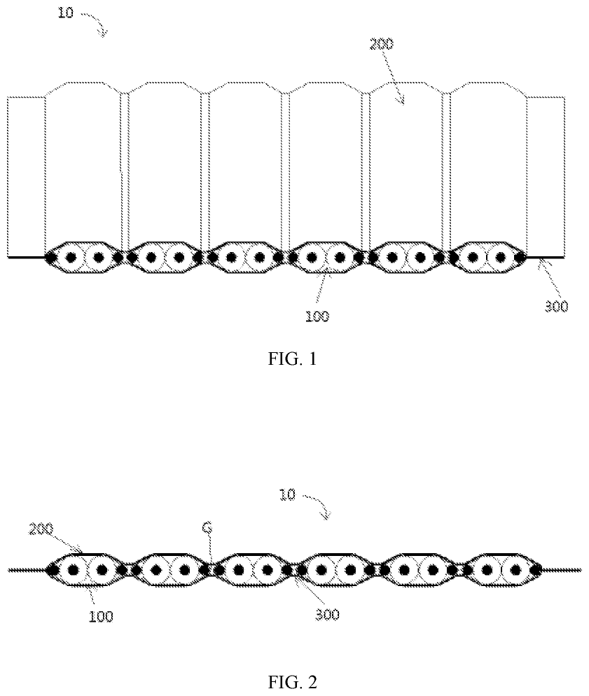

In the embodiment shown in FIGS. 1 to 3, a ribbon cable 10 includes two or more cable groups 100 arranged side by side, wherein there is a gap G between every two adjacent cable groups 100. The ribbon cable 10 further includes a first covering film 200 and a second covering film 300 arranged on opposite sides of the two or more cable groups 100, respectively.

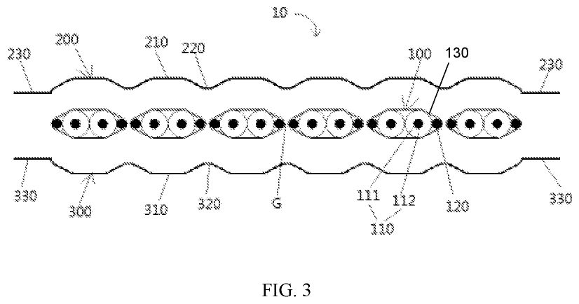

As shown in FIG. 3, the first covering film 200 includes a first bonding portion 210 and a first spacing portion 220, and the second covering film 300 includes a second bonding portion 310 and a second spacing portion 320. The first bonding portion 210 and the second bonding portion 310 are bonded to each cable group 100 of the two or two cable groups 100, the first spacing portion 220 and the second spacing portion 320 are located at the gap G, and the first spacing portion 220 and the second spacing portion 320 are separated from each other. More specifically, the gap G is between the first spacing portion 220 and the second spacing portion 320; that is, the first spacing portion 220 and the second spacing portion 320 are not bonded to each other, but the height of the gap G is smaller than a diameter of a cable of the cable groups 100 to provide external force buffering or vibration damping for the cable groups 100.

In an embodiment of the ribbon cable 10, the covering films 200, 300 are provided on opposite sides of the two or more cable groups 100 arranged side by side to form a stable double-sided cable fixing structure, thus the cables 100 do not easily fall off and become loose.

A surface of the first covering film 200 facing the two or more cable groups 100 is provided with hot melt adhesive by which the first covering film 200 is bonded to each cable group 100 of the cable groups 100, and a surface of the second covering film 300 facing the cable groups 100 is provided with hot melt adhesive by which the second covering film 300 is bonded to each cable group 100 of the cable groups 100. That is, the first covering film 200 and the second covering film 300 may be bonded to the cable groups 100 by thermal fusion. In another embodiment, the first covering film 200 and the second covering film 300 may be bonded to the cable groups 100 by an adhesive. In the ribbon cable 10, since a double-sided covering structure is adopted, the hot melt adhesive on the covering films 200, 300 is not in contact with air, is less affected by the external environment, and is not prone to failure.

As shown in FIG. 3, the first covering film 200 further includes a first edge portion 230, and the second covering film 300 further includes a second edge portion 330. The first edge portion 230 and the second edge portion 330 are located at the outer side of the outermost cable group 100 of the two or two cable groups 100. The first edge portion 230 and the second edge portion 330 are bonded to each other. More specifically, the first edge portion 230 and the second edge portion 330 are bonded to each other by the hot melt adhesive on the respective surfaces. In the ribbon cable 10, since a double-sided covering structure is adopted, the first edge portion 230 and the second edge portion 330 are bonded to each other, the hot melt adhesive on the covering films 200, 300 is further not in contact with air, is less affected by the external environment, and is not prone to failure.

In an embodiment, the first covering film 200 includes an insulation polyester tape or a shielding tape, and the second covering film 300 includes an insulation polyester tape or a shielding tape. That is, the first covering film 200 and/or the second covering film 300 may provide improved electromagnetic shielding for the cable groups 100, and may take the form of a layer/tape. The first covering film 200 and/or the second covering film 300 may be made of an insulation polymer material. For example, the first covering film 200 and/or the second covering film 300 may be made of an insulation material such as polyethylene terephthalate (abbreviated as “PET”). The first covering film 200 and/or the second covering film 300 may also be made of a metallic shielding material. For example, the first covering film 200 and/or the second covering film 300 may be made of a metal shielding material such as copper or aluminum. In other embodiments, the first covering film 200 and/or the second covering film 300 may also be made of other materials suitable for the fixing and shielding of high-speed cables.

As shown in FIG. 3, each of the two or more cable groups 100 includes: at least one insulation cable 110 including a core wire 111 and an insulation material layer 112 wrapped around the core wire 111; and/or at least one ground wire 120. The at least one insulation cable 110 and/or the at least one ground wire 120 of each cable group 100 of the two or more cable groups 100 are wound together by an insulation film 130. In other embodiments, the cable groups 100 may adopt one of the following combinations of the insulation cable 110 and/or the ground wire 120: single insulation cable 110, a plurality of insulation cables 110, single ground wire 120, a plurality of ground wires 120, a combination of single insulation cable 110 and a plurality of ground wires 120, a combination of a plurality of insulation cables 110 and single ground wire 120, and a combination of a plurality of insulation cables 110 and a plurality of ground wires 120. Moreover, the structures and combinations of the insulation cables 110 and/or the ground wires 120 of each cable group 100 of the ribbon cable 10 may be the same or different according to requirements.

As shown in FIG. 3, each of the two or more cable groups 100 includes: two adjacent insulation cables 110, and one ground wire 120 on either side of the two adjacent insulation cables 110. Moreover, each cable group 100 of the ribbon cable 10 adopts the same structure and combination. For example, in the exemplary embodiment shown in FIGS. 1 to 3, the two or more cable groups 100 of the ribbon cable 10 include six cable groups 100. However, it should be noted that the number of the cable groups 100 of the ribbon cable 10 may vary according to the actual situation, for example, the number of the cable groups 100 may be two, three, four, five, seven or more. In addition, the structure and combination of each cable group 100 may be the same or different.

The ribbon cable 10 provided by the present disclosure may be a high-speed data transmission ribbon cable such as a twinaxial cable. The ribbon cable 10 can be directly produced with existing equipment, without the need to modify the existing equipment or add additional film sticking devices.

It should be appreciated by those skilled in this art that the above embodiments are intended to be illustrative, and many modifications may be made to the above embodiments by those skilled in this art. Further, various structures described in various embodiments may be freely combined with each other without conflicting in configuration or principle.

Although the present disclosure have been described hereinbefore in detail with reference to the accompanying drawings, it should be appreciated that the disclosed embodiments in the accompanying drawings are intended to illustrate embodiments of the present disclosure by way of example, and should not be construed as a limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

What is claimed is:

1. A ribbon cable, comprising:
a plurality of cable groups arranged side by side with a gap between each pair of adjacent cable groups;
a first covering film arranged on a first side of the cable groups, the first covering film has a first bonding portion and a first spacing portion; and
a second covering film arranged on a second side of the cable groups opposite the first covering film, the second covering film has a second bonding portion and a second spacing portion, the first bonding portion and the second bonding portion are bonded to each of the cable groups, the first spacing portion and the second spacing portion are located at the gap and are separated from each other.

2. The ribbon cable of claim 1, wherein the gap is between the first spacing portion and the second spacing portion.

3. The ribbon cable of claim 1, wherein the first covering film has a first edge portion and the second covering film has a second edge portion bonded to the first edge portion.

4. The ribbon cable of claim 3, wherein the first edge portion and the second edge portion are located at an outer side of an outermost cable group of the cable groups.

5. The ribbon cable of claim 1, wherein the first covering film is bonded to each of the cable groups by a hot melt adhesive disposed on a surface of the first covering film facing the cable groups.

6. The ribbon cable of claim 5, wherein the second covering film is bonded to each of the cable groups by the hot melt adhesive disposed on a surface of the second covering film facing the cable groups.

7. The ribbon cable of claim 1, wherein the first covering film is an insulation polyester tape or a shielding tape.

8. The ribbon cable of claim 1, wherein the second covering film is an insulation polyester tape or a shielding tape.

9. The ribbon cable of claim 1, wherein each of the cable groups has an insulation cable with a core wire and an insulation layer wrapped around the core wire.

10. The ribbon cable of claim 1, wherein each of the cable groups has a ground wire.

11. The ribbon cable of claim 9, wherein each of the cable groups has a ground wire.

12. The ribbon cable of claim 11, wherein the insulation cable and/or the ground wire are wound together by an insulation film.

13. The ribbon cable of claim 12, wherein each cable group has a pair of adjacent insulation cables.

14. The ribbon cable of claim 13, wherein the ground wire is located on either side of the adjacent insulation cables.

15. The ribbon cable of claim 1, wherein the plurality of cable groups include six cable groups.

16. The ribbon cable of claim 1, wherein the ribbon cable is a high-speed data transmission ribbon cable.
